(19) United States
(12) Patent Application Publication
(10) Pub. No.: US 2026/0314541 A1
(43) Pub. Date: Oct. 15, 2026

(54) MICROGREEN SEED STARTER SYSTEM

(71) Applicant: GoMicroFresh LLC., Huntington Beach, CA (US)

(72) Inventor: Thomas Semark, Costa Mesa, CA (US)

(21) Appl. No.: 19/465,364

(22) Filed: Jan. 30, 2026

Related U.S. Application Data
(60) Provisional application No. 63/753,275, filed on Feb. 3, 2025.

(51) Int. Cl. A01G 9/029; A01G 9/24

(52) U.S. Cl. CPC A01G 9/029; A01G 9/247; A01G 9/249

(57) ABSTRACT

A microgreen seed starter system includes a dome having a top portion and a bottom portion configured to couple together to form an enclosed growing area. The bottom portion defines an internal cavity configured to receive water to form a reservoir. One or more porous growing trays are positioned within the dome and are configured to obtain moisture from the reservoir via capillary action. The top portion includes a groove sized and shaped to receive an integrated growing light, which may be removable and reattachable. The dome includes stackable attachment features enabling multiple domes to be stacked while maintaining illumination for each enclosed growing area. The bottom portion may have a clover-shaped base and the top portion may be transparent or translucent to admit light. The system provides space-efficient, low-maintenance indoor cultivation of microgreens and other plants.

### CROSS-REFERENCE TO RELATED APPLICATIONS

The present application claims priority to U.S. Provisional Application Ser. No. 63/753,275 filed Feb. 3, 2025, which is hereby incorporated in its entirety at least by reference.

### BACKGROUND OF THE INVENTION

### 1. Field of the Invention

The present invention relates to growing systems but more particularly a microgreen seed starter system.

### 2. Description of Related Art

Microgreens are commonly grown in indoor settings to provide a convenient, nutrient-dense food source. Existing microgreen cultivation systems often involve plastic trays or containers combined with soil-based or fiber-based growing media. Many of these prior art systems lack integrated lighting, rely on external grow lights, or simply use ambient sunlight. Moreover, they may not provide stackable designs that allow multiple levels of microgreens to be grown simultaneously while minimizing space requirements.

Some microgreen kits rely on traditional watering methods, which require frequent monitoring and can be messy. Others employ hydroponic or soil-less solutions, but still demand separate equipment for lighting and moisture control. Consequently, there remains a need for a system that integrates stackability, automated or low-maintenance watering using porous materials, and optional built-in lighting—all in one compact configuration. The present invention addresses these shortcomings by providing a stackable dome design that encloses trays of microgreens, offers an integrated lighting option, and maintains optimal humidity for consistent growth.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is an object of the invention to provide a microgreen seed starter system, comprising a dome having a bottom portion and a top portion, wherein the top portion is adapted to act as a lid and is configured to meet with the bottom portion to form an enclosed growing area within the dome; wherein the bottom portion defines an internal cavity configured to receive water to form a reservoir; at least one growing tray comprised of a porous material configured to be received within the dome and positioned to obtain moisture from the reservoir during use via capillary action; a groove positioned on the top portion; and an integrated growing light receivable in the groove.

In one embodiment, the bottom portion includes a plurality of cavities configured to receive a plurality of growing trays within the internal cavity. In one embodiment, the bottom portion is in a clover shape. In one embodiment, the bottom portion includes a hollow stackable attachment receiving element configured to receive a protruding cylinder on an additional dome. In another embodiment, the stackable attachment receiving element extends upwardly into the dome and defines a maximum fill height for water in the reservoir. In one embodiment, the top portion is transparent, translucent or combinations thereof such that a predetermined amount of light is enabled to enter the enclosed growing area. In one embodiment, the bottom portion includes a flat bottom surface and a curved side surface leading to a vertical rim, and the top portion includes a flanged surface configured to meet with the vertical rim to complete the dome. In one embodiment, the integrated growing light is removable and reattachable relative to the groove in the top portion. In another embodiment, the integrated growing light is circular in design and the groove is cylindrical in shape. In yet another embodiment, the top portion includes a plurality of grooves extending outwardly from a central region of the top portion, the plurality of grooves configured to receive a handle of the integrated growing light in a plurality of handle positions. In another embodiment, a plurality of vents formed in the dome to promote airflow within the enclosed growing area are provided. In yet another embodiment, the plurality of vents includes a first set of vents and a second set of vents, and the first set of vents is provided on a top region of the dome within the plurality of grooves and a second set of vents is provided on side regions of the dome.

In another aspect of the invention, a microgreen seed starter system is provided, comprising a dome having a bottom portion and a top portion, wherein the top portion is adapted to act as a lid and is configured to meet with the bottom portion to form an enclosed growing area within the dome; wherein the bottom portion defines an internal cavity configured to receive water to form a reservoir; at least one growing tray comprised of a porous material configured to be received within the dome and positioned to obtain moisture from the reservoir during use via capillary action; a stackable attachment element on an exterior top surface of the top portion, the stackable attachment element comprising a protruding cylinder; and a hollow stackable attachment receiving element on an exterior bottom surface of the bottom portion, the hollow stackable attachment receiving element being configured to receive the protruding cylinder of an additional dome to enable stacking of a plurality of domes.

In one embodiment, a groove positioned on the top portion is provided, the groove being sized and shaped to receive an integrated growing light, wherein a top surface of the integrated growing light is flush with an adjacent surface of the top portion such that, when the additional dome is stacked on the top portion, the integrated growing light does not interfere with placement of the additional dome on the top portion.

The foregoing has outlined rather broadly the more pertinent and important features of the present invention so that the detailed description of the invention that follows may be better understood and so that the present contribution to the art can be more fully appreciated. Additional features of the invention, which will be described hereinafter, form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF THE DRAWINGS

Other features and advantages of the present invention will become apparent when the following detailed description is read in conjunction with the accompanying drawings, in which:

FIG. 1 is a perspective view of the microgreen seed starter system according to an embodiment of the present invention.

FIG. 2 is a front view of the microgreen seed starter system according to an embodiment of the present invention.

FIG. 3 is a top view of the microgreen seed starter system according to an embodiment of the present invention.

FIG. 4 is a detailed perspective view of the stackable attachment element on the top surface of the dome according to an embodiment of the present invention.

FIG. 5 is a bottom view of the microgreen seed starter system according to an embodiment of the present invention.

FIG. 6 is a detailed perspective view of the stackable attachment receiving element on the bottom surface of the dome according to an embodiment of the present invention.

FIG. 7 is a perspective view of the bottom portion of the dome with the top portion of the dome removed according to an embodiment of the present invention.

FIG. 8A is a top perspective view of the microgreen seed starter system showing the integrated light.

FIG. 8B is a sectional view of FIG. 8A.

FIG. 8C is a top view of FIG. 8A.

FIG. 9 illustrates multiple domes stacked according to an embodiment of the present invention.

FIG. 10A-F illustrates various views of an alternate microgreen seed starter system according to an embodiment of the present invention.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a microgreen seed starter system.

It is to be understood that the terminology used herein is for the purpose of describing particular embodiments only and is not intended to be limiting. The terms “a” or “an,” as used herein, are defined as to mean “at least one.” The term “plurality,” as used herein, is defined as two or more. The term “another,” as used herein, is defined as at least a second or more. The terms “including” and/or “having,” as used herein, are defined as comprising (i.e., open language). The term “providing” is defined herein in its broadest sense, e.g., bringing/coming into physical existence, making available, and/or supplying to someone or something, in whole or in multiple parts at once or over a period of time. These terms generally refer to a range of numbers that one of skill in the art would consider equivalent to the recited values (i.e., having the same function or result). In many instances these terms may include numbers that are rounded to the nearest significant figure.

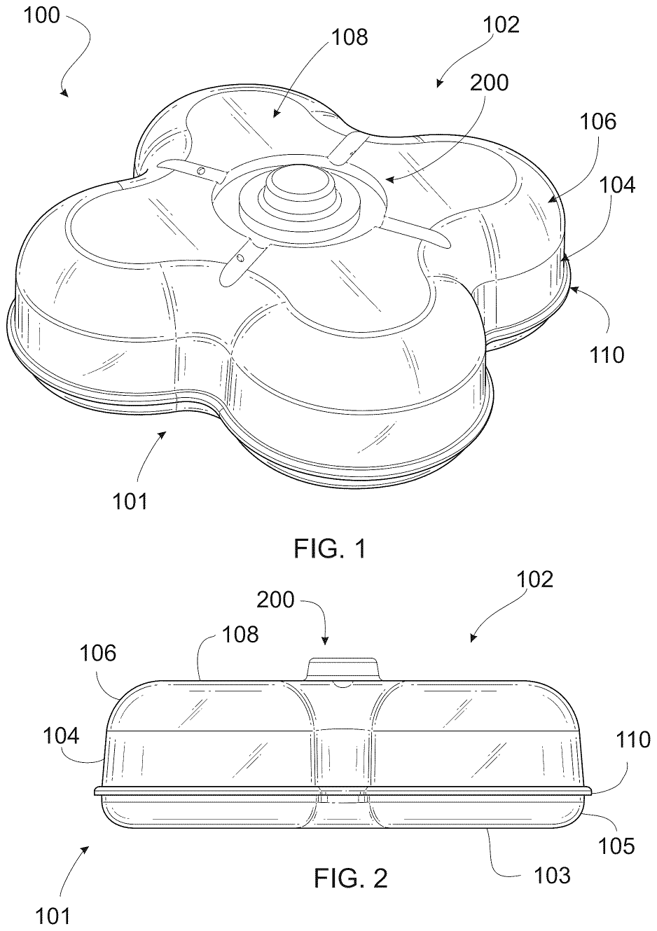

FIGS. 1-2, are various views of the microgreen seed starter system according to an embodiment of the present invention. Referring now to FIGS. 1-2, the microgreen seed starter system comprises a dome 100 having a top portion 102 and a bottom portion 101, wherein the top portion is adapted to act as a lid creating a growing area within the dome. In one embodiment, the top portion 102 is transparent or opaque such that a predetermined amount of light is enabled to enter the growing area. The light and growing aspect of the system will be discussed in greater detail below.

Still referring to FIGS. 1-2, the bottom portion includes a flat bottom surface 103 and a curved side surface 105 leading to a vertical rim 115 (FIG. 7). In one embodiment, the bottom portion is in the shape of a clover. In another embodiment, the bottom portion is the shape of a four-leaf clover. In other embodiments, the bottom portion may be in any shape, including but not limited to circular, rectangular, triangular, polygonal, octagonal, etc. In one embodiment, the top portion 102 includes a flat top surface 108, a curved surface 106, and a lower flat vertical surface 104 which leads into a flanged surface 110. The flanged surface 110 is configured to meet with the vertical rim to complete the dome having an enclosed growing area.

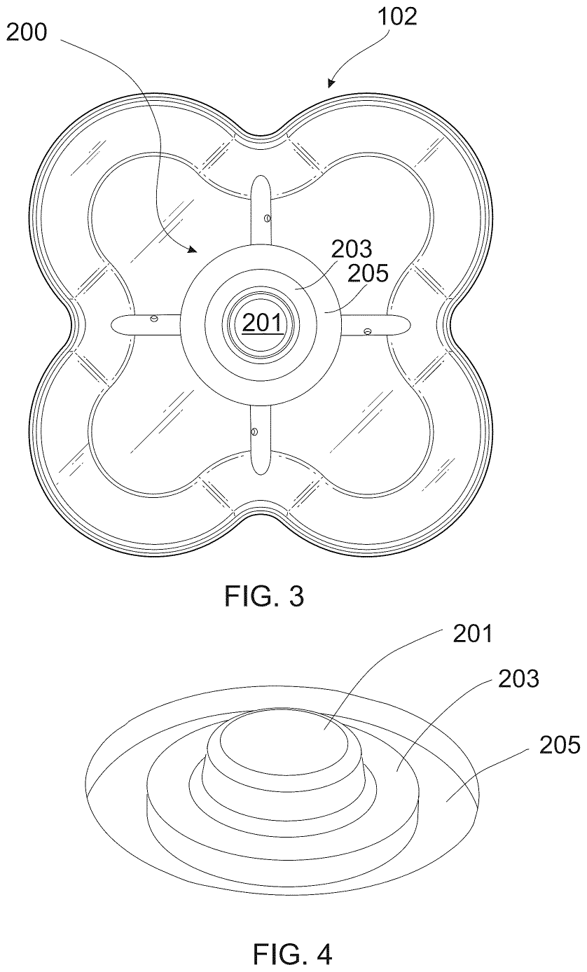

In one embodiment, the top portion includes a stackable attachment element 200 which allows other domes to stack on top which saves space and creates the microgreen seed starter system. Referring now to FIGS. 3-4, a top view and a detailed view showing the stackable attachment element 200. In one embodiment, the stackable attachment element 200 includes a protruding cylinder 201, and flat cylindrical base 203, and a groove 205 in a cylindrical shape. It should be noted that although the stackable attachment element 200 features include a cylindrical arrangement, other shapes may be provided, which would include the shapes to be consistent between features.

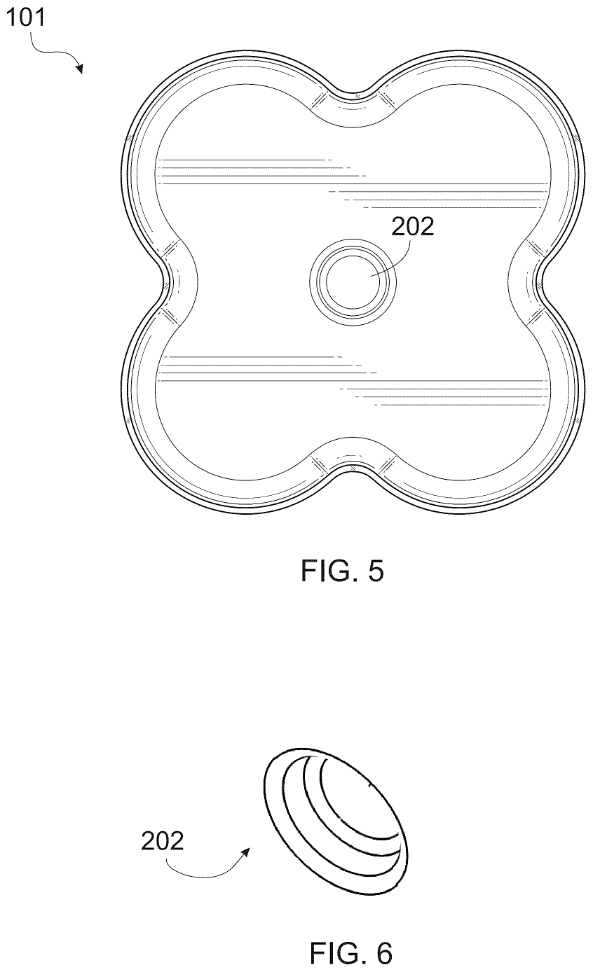

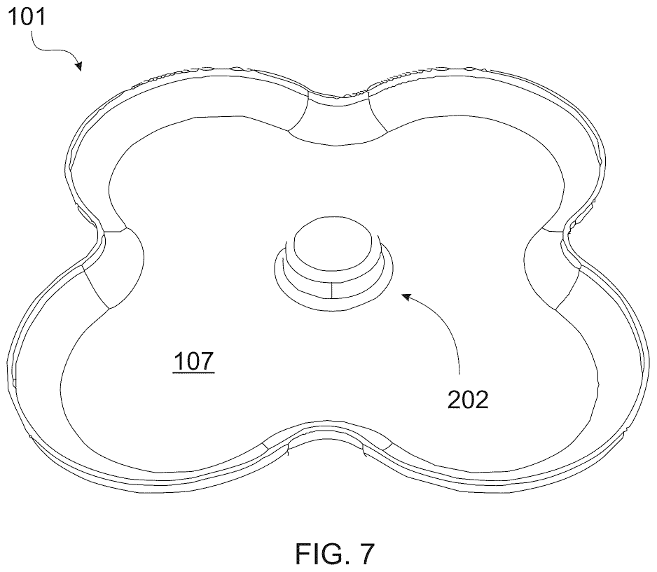

FIGS. 5-6 are bottom view and detailed views of the stackable attachment receiving element on the bottom surface of the dome according to an embodiment of the present invention. Referring now to FIGS. 5-6, the bottom portion 101 of the dome includes a stackable attachment receiving element 202, wherein the stackable attachment receiving element 202 is configured to receive a protruding cylinder 201 on another dome. As previously stated, other shapes may be provided. As one skilled in the art would appreciate, the shapes of the protruding cylinder and receiving element should match to allow for a press-fit connection. Due to the flat surfaces of the top and bottom surfaces, the fit connection needs not to be of much friction, or any friction, only aligned within each other to enable stacking with support against falling or aid additional units being stacked.

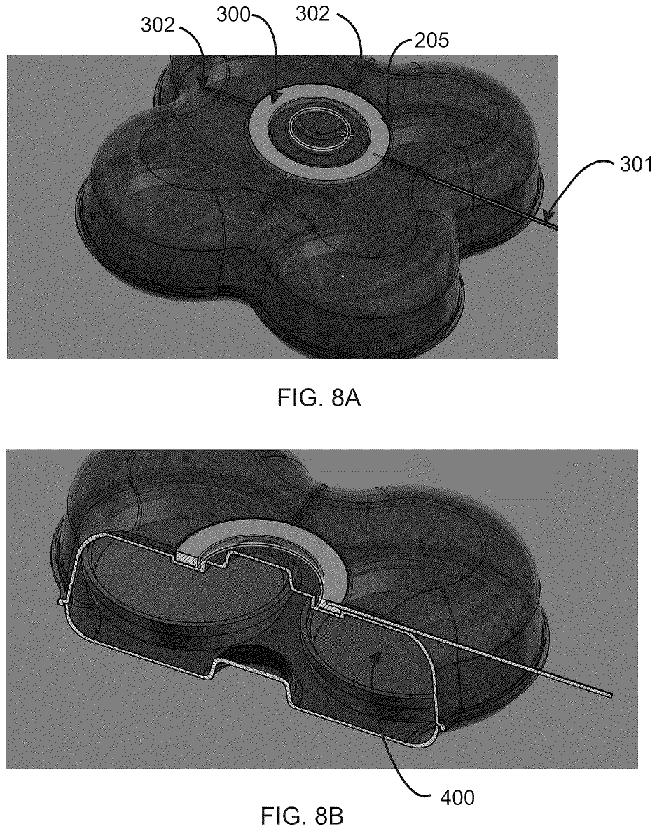

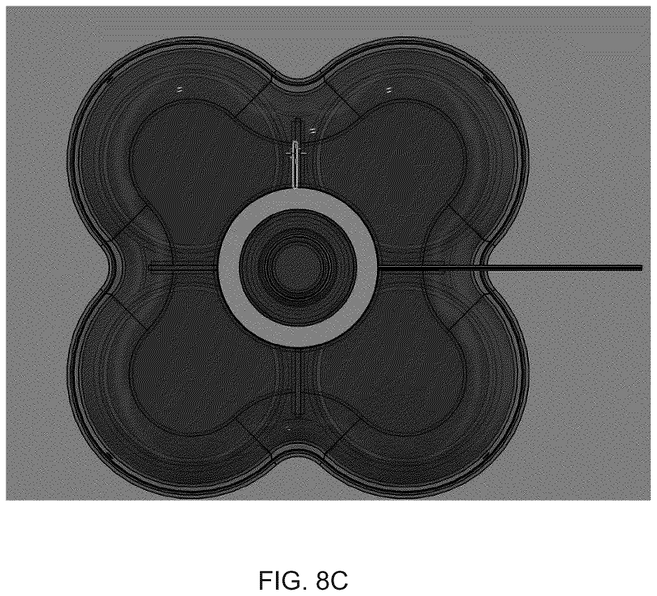

FIG. 7 illustrates the top view of the bottom portion 101 which shows the topside of the stackable attachment receiving element 202. In this view, it shows the depth of the receiving element and how the protrusion of the stackable attachment receiving element may fit within the recess. In this view, one can see the cavities 107 or internal growing space that is formed by the bottom portion. This area is configured to enable growing trays to sit within a predetermined pool of water for growing. More specifically, water is added to the internal cavity 107 at a predefined level and a plurality of growing trays 400 (FIG. 8B) are added which support seeds, such as microgreen seeds. In one embodiment, the growing trays are constructed of clay material, and during use seeds are applied directly in the clay growing trays without the need for soil or medium. Advantageously, the water added to the bottom portion seeps through the porous clay material to effectively water with seeds, and plant growth providing a “set it and forget it” ease of use. In some embodiments, the grow tray contains a reduced quantity of grow medium relative to conventional soil-filled trays. For example, the grow medium may comprise coco coir pellets and/or soil, while still allowing bottom-watering and/or humidity-based germination as described herein. In various embodiments, water is delivered to the seeds by (i) capillary wicking through a porous tray wall, (ii) capillary transfer through a wick element extending into the reservoir, (iii) bottom-watering through apertures in the tray floor, and/or (iv) periodic top-watering or misting.

Still referring to FIG. 7, the receiving element 202 acts fill line to allow the user to put the correct amount of water in the reservoir/cavities 107, wherein the user should not exceed the height of the receiving element.

Referring now to FIGS. 8A-C, the growing trays are visible as well as the integrated light 300. In one embodiment, the integrated light 300 is circular in design and configured to sit within the groove 205 such that the top surface of the integrated light is flush with flat cylindrical base 203, wherein the integrated light does not interfere with the stackability of stacking multiple domes. In some embodiments, the top portion includes a series of grooves 302 that extend at 90 degree angles from the stackable attachment element 200, which enables the handle 301 of the integrated light 300 to be placed in a number of handle positions while also ensuring the handle does not impede the stackability of the system. The integrated light may be removed and added as needed, and may be integrated into a timing system that automatically controls when the light turns on and off depending on the demands of the growing cycle as well known in the art. The light 300 may be powered by USB, USB-C, rechhargable battery, inductive charging, etc. As with other elements in the system, the shape of the integrated light may vary which requires adjusting the supporting features. Likewise, the number of handle receivable grooves 302 may vary, as well as the location of the grooves 302.

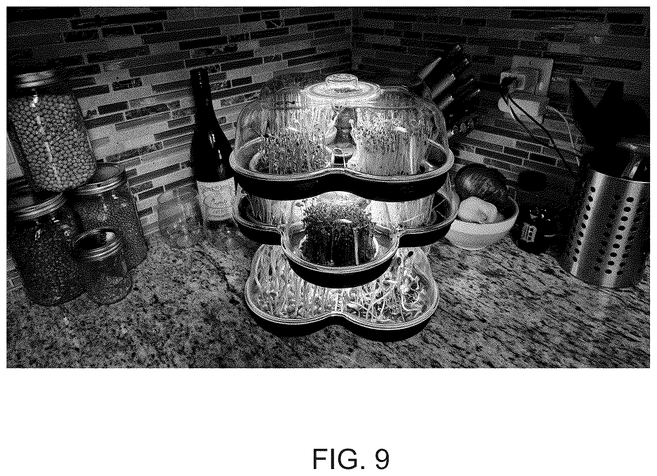

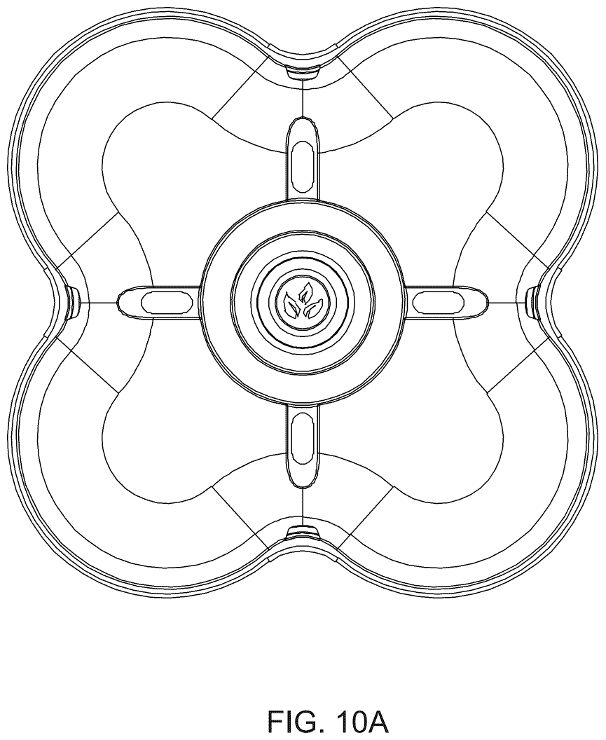

FIG. 9 shows the stackable nature of the system, wherein FIG. 9 shows three domes stacked with integrated lights, it should be understood that any number of domes may be stacked. The grooves enable and alignment for stacking.

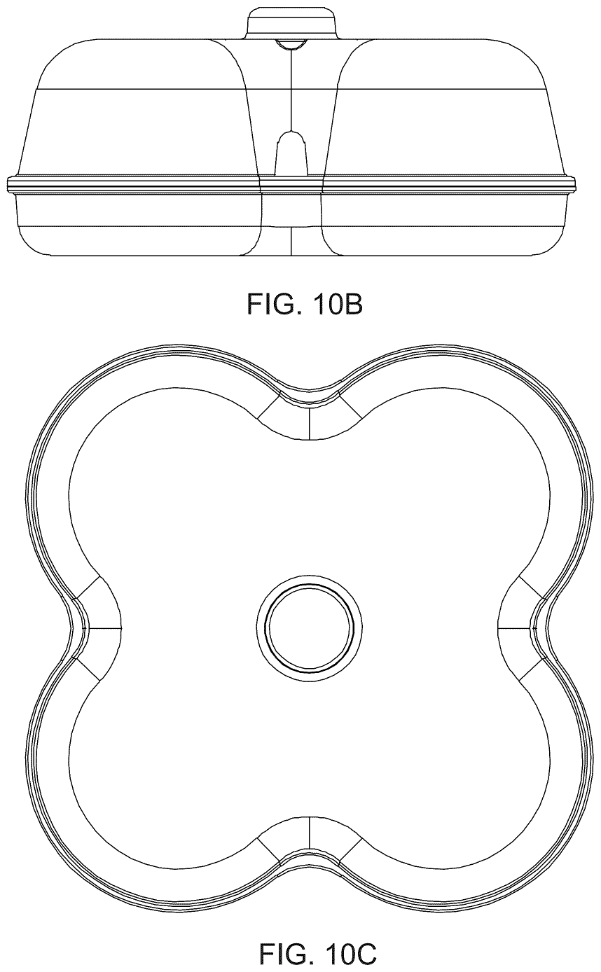

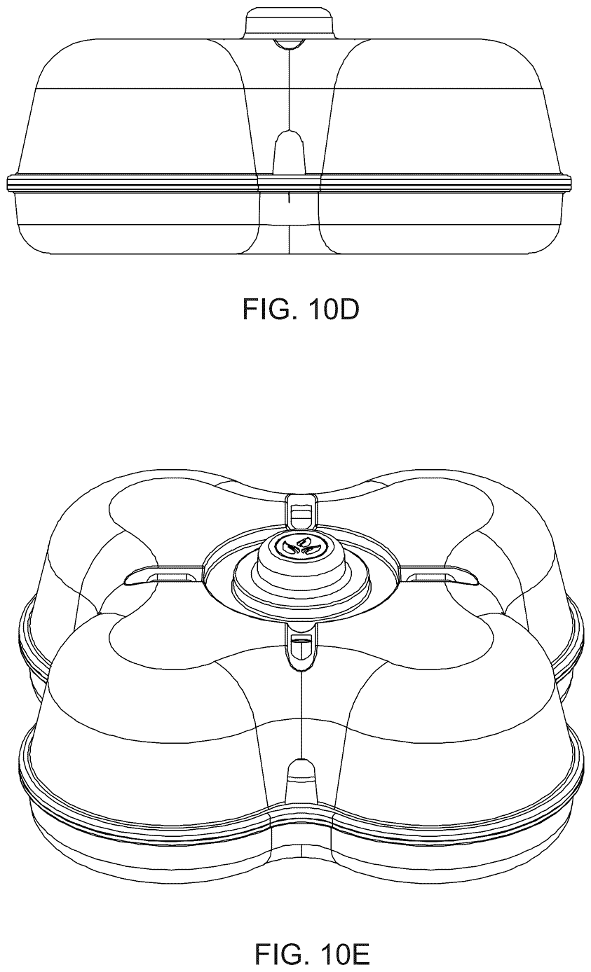

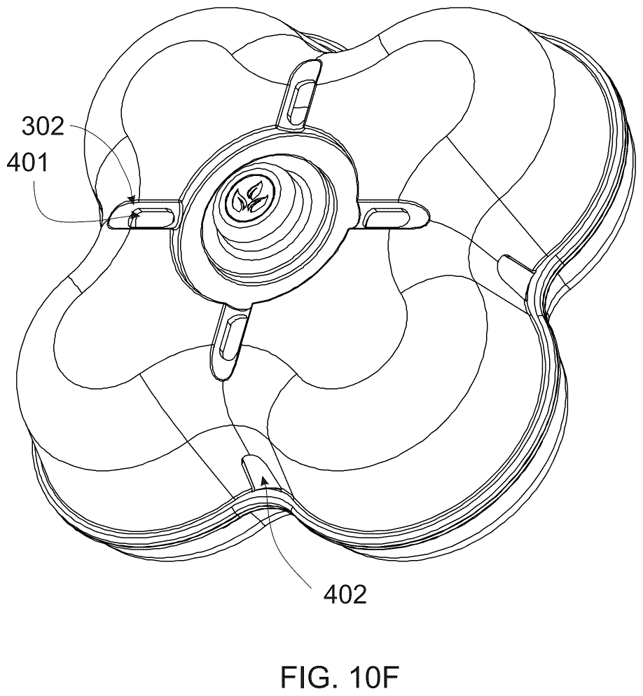

Referring now to FIGS. 10A-F, various views of an alternate microgreen seed starter system are illustrated. Best seen in FIG. 10F, multiple vents 401 and 402 are provided, both within the grooves 302 and on the sides of the dome. In the illustrated embodiment, there are four vents 401 on the top of the dome and four side vents 402. Advantageously, the vents help balance high humidity needed for germination with the airflow required to prevent mold, bacterial growth, and, damping off. It regulates moisture levels, prevents stagnant air from damaging seedlings, and strengthens stems. In some embodiments, the vents may include removable vent plugs or screens.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. In other words, the terminology and phraseology used in this description and the abstract are for illustrative purposes and should not be considered limiting. Therefore, while exemplary illustrative embodiments of the invention have been described, numerous variations and alternative embodiments will occur to those skilled in the art. Such variations and alternative embodiments are contemplated, and can be made without departing from the spirit and scope of the invention.

For example, although microgreens are the intended growing organism, other plants or organisms may be grown.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, references to “first,” “second,” “third,” and etc. members throughout the disclosure (and in particular, claims) are not used to show a serial or numerical limitation but instead are used to distinguish or identify the various members of the group.

What is claimed is:

1. A microgreen seed starter system, comprising:
a dome having a bottom portion and a top portion, wherein the top portion is adapted to act as a lid and is configured to meet with the bottom portion to form an enclosed growing area within the dome;
wherein the bottom portion defines an internal cavity configured to receive water to form a reservoir;
at least one growing tray comprised of a porous material configured to be received within the dome and positioned to obtain moisture from the reservoir during use via capillary action;
a groove positioned on the top portion; and
an integrated growing light receivable in the groove.

2. The microgreen seed starter system of claim 1, wherein the bottom portion includes a plurality of cavities configured to receive a plurality of growing trays within the internal cavity.

3. The microgreen seed starter system of claim 2, wherein the bottom portion is in a clover shape.

4. The microgreen seed starter system of claim 1, wherein the bottom portion includes a hollow stackable attachment receiving element configured to receive a protruding cylinder on an additional dome.

5. The microgreen seed starter system of claim 4, wherein the stackable attachment receiving element extends upwardly into the dome and defines a maximum fill height for water in the reservoir.

6. The microgreen seed starter system of claim 1, wherein the top portion is transparent, translucent or combinations thereof such that a predetermined amount of light is enabled to enter the enclosed growing area.

7. The microgreen seed starter system of claim 1, wherein the bottom portion includes a flat bottom surface and a curved side surface leading to a vertical rim, and the top portion includes a flanged surface configured to meet with the vertical rim to complete the dome.

8. The microgreen seed starter system of claim 1, wherein the integrated growing light is removable and reattachable relative to the groove in the top portion.

9. The microgreen seed starter system of claim 8 wherein the integrated growing light is circular in design and the groove is cylindrical in shape.

10. The microgreen seed starter system of claim 9, wherein the top portion includes a plurality of grooves extending outwardly from a central region of the top portion, the plurality of grooves configured to receive a handle of the integrated growing light in a plurality of handle positions.

11. The microgreen seed starter system of claim 10, further comprising a plurality of vents formed in the dome to promote airflow within the enclosed growing area.

12. The microgreen seed starter system of claim 11, wherein the plurality of vents includes a first set of vents and a second set of vents, and the first set of vents is provided on a top region of the dome within the plurality of grooves and a second set of vents is provided on side regions of the dome.

13. A microgreen seed starter system, comprising:
a dome having a bottom portion and a top portion, wherein the top portion is adapted to act as a lid and is configured to meet with the bottom portion to form an enclosed growing area within the dome;
wherein the bottom portion defines an internal cavity configured to receive water to form a reservoir;
at least one growing tray comprised of a porous material configured to be received within the dome and positioned to obtain moisture from the reservoir during use via capillary action;
a stackable attachment element on an exterior top surface of the top portion, the stackable attachment element comprising a protruding cylinder; and
a hollow stackable attachment receiving element on an exterior bottom surface of the bottom portion, the hollow stackable attachment receiving element being configured to receive the protruding cylinder of an additional dome to enable stacking of a plurality of domes.

14. The microgreen seed starter system of claim 13, further comprising a groove positioned on the top portion, the groove being sized and shaped to receive an integrated growing light, wherein a top surface of the integrated growing light is flush with an adjacent surface of the top portion such that, when the additional dome is stacked on the top portion, the integrated growing light does not interfere with placement of the additional dome on the top portion.
